(19) United States
(12) Patent Application Publication
(10) Pub. No.: US 2010/0293791 A1
(43) Pub. Date: Nov. 25, 2010

(54) UTILITY KNIFE WITH FUNCTION HOOK CARABINEER

(76) Inventor: Kristopher Joseph Mueller, Asheville, NC (US)

Correspondence Address: PATTERSON & SHERIDAN, L.L.P., 3040 POST OAK BOULEVARD, SUITE 1500, HOUSTON, TX, 77056, US

(21) Appl. No.: 12/713,942

(22) Filed: Feb. 26, 2010

Related U.S. Application Data
(60) Provisional application No. 61/216,503, filed on May 19, 2009.

(51) Int. Cl. B26B 5/00; B25G 1/00

(52) U.S. Cl. 30/162; 30/296.1; 30/329

(57) ABSTRACT

The present invention generally relates to a knife with a hook portion. In one aspect, a utility knife is provided. The utility knife includes a handle having a first end with an opening and a second end with a hook portion. The utility knife further includes a blade and a blade holder disposed in the handle. The blade holder is configured to hold the blade, wherein the blade holder is movable relative to the handle between an extended position where a cutting edge of the blade extends through the opening of the handle and a retracted position where the cutting edge of the blade is disposed in the handle. In another aspect, a method of operating a utility knife is provided.

### CROSS-REFERENCE TO RELATED APPLICATIONS

This application claims benefit of U.S. provisional patent application Ser. No. 61/216,503, filed May 19, 2009, which is herein incorporated by reference.

### BACKGROUND OF THE INVENTION

1. Field of the Invention

Embodiments of the present invention generally relate to a utility knife. More particularly, embodiments of the present invention relate to a utility knife having a hook portion.

2. Description of the Related Art

A conventional utility knife typically includes a handle and a blade. The blade in the conventional utility knife is movable relative to the handle between a retracted position and an extended position. In the retracted position, the blade is positioned within the handle, and in the extended position, a portion of the blade extends from the handle. The handle in the conventional utility knife may be made from a single piece or several pieces. Further, the body of the handle in the conventional utility knife is relatively straight. During a cutting operation, the user typically pushes on the knife or pulls on the knife in order to cut the material.

### SUMMARY OF THE INVENTION

The present invention generally relates to a knife with a hook portion. In one aspect, a utility knife is provided. The utility knife includes a handle having a first end with an opening and a second end with a hook portion. The utility knife further includes a blade and a blade holder disposed in the handle. The blade holder is configured to hold the blade, wherein the blade holder is movable relative to the handle between an extended position where a cutting edge of the blade extends through the opening of the handle and a retracted position where the cutting edge of the blade is disposed in the handle.

In another aspect, a method of operating a utility knife is provided. The method includes the step of providing the utility knife. The utility knife comprising a blade, a blade holder, a button, a handle having a first end with an opening and a second end with a hook portion. The method further includes the step of grasping the knife in a manner that utilizes the handle. The method also includes the step of manipulating the button on the knife to move the blade holder from a retracted position where a cutting edge of the blade is disposed in the handle to an extended position where the cutting edge of the blade extends through the opening of the handle. Additionally, the method includes the step of applying a force on the knife such that a portion of the force is applied to the hook portion of the handle.

In a further aspect, a utility knife is provided. The utility knife includes a handle having a hand grip positioned between a hook portion and a slip guard. The utility knife further includes a blade holder configured to hold a blade, wherein the blade holder is movable relative to the handle between an extended position where a cutting edge of the blade extends through an opening of the handle and a retracted position where the cutting edge of the blade is disposed in the handle. Additionally, the utility knife includes an arm member disposed proximate the hook portion. The arm member includes a first end attached to the handle at a pivot point.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a view illustrating a knife with a blade in a retracted position.

FIG. 2 is a view illustrating the knife with the blade in an extended position.

FIG. 3 is a view illustrating a knife with a latch in a closed position.

FIG. 4 is a view illustrating a knife with a latch in an opened position.

### DETAILED DESCRIPTION

The present invention generally relates to a utility knife with a hook carabineer. To better understand the aspects of the present invention and the methods of use thereof, reference is hereafter made to the accompanying drawings.

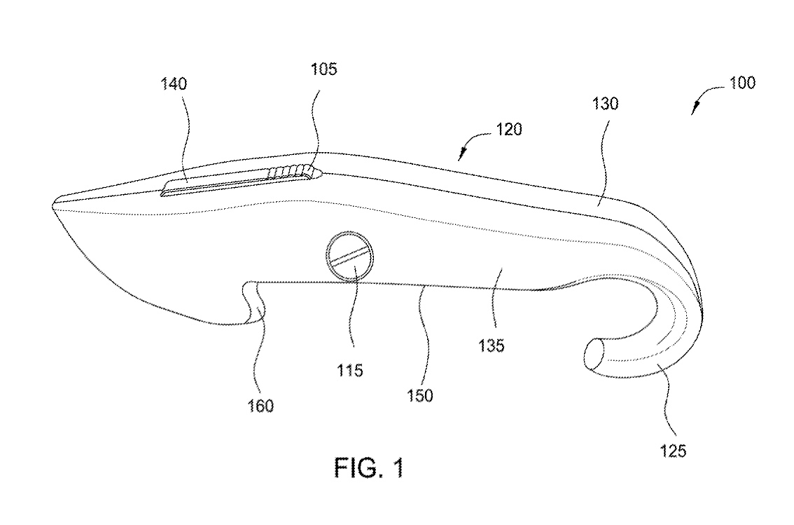

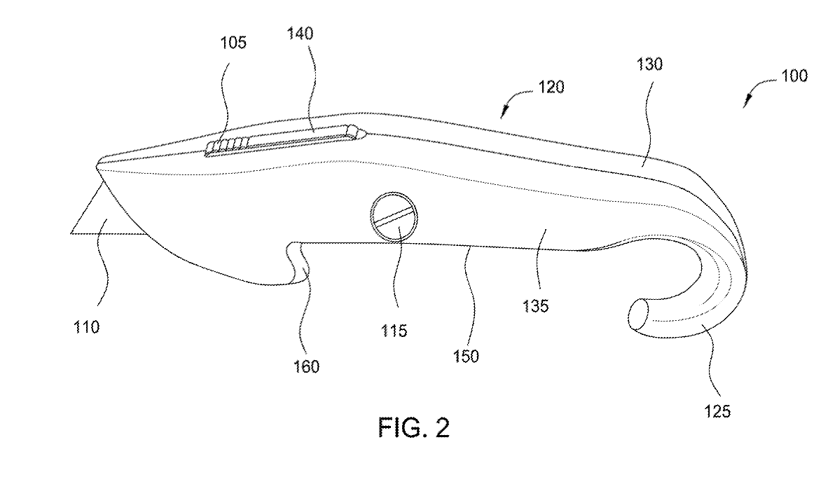

FIGS. 1 and 2 are views illustrating a knife 100 having a blade holder in a retracted position and an extended position. The blade holder is movable between the retracted and the extended position by manipulating a button 105 on an upper portion of the knife 100. In the extended position, the cutting edge of a blade 110 extends from an opening in a handle 120 of the knife 100. In the retracted position, the cutting edge of the blade 110 is disposed within the handle 120 of the knife 100.

The handle 120 includes a first portion 130 and a second portion 135. The first portion 130 is attached to the second portion 135 by a connection member 115, such as a screw. The connection member 115 is configured to be removable to allow the first portion 130 to be removed from the second portion 135 in order to insert (or replace) the blade 110 in the blade holder. Each portion 130, 135 includes a cut out on an upper portion that forms a slot 140 when the portions 130, 135 are connected. The slot 140 is configured to allow the button 105 to slide as the button 105 moves the blade holder between the retracted position (FIG. 1) and the extended position (FIG. 2). The handle 120 includes a handgrip 150 disposed between a slip guard 160 and a hook portion 125. The handgrip 150 is shaped such that the knife 100 will ergonomically fit in the hand of a user during a cutting operation. The handle 120 may be constructed from a metallic, a synthetic or a composite material.

The knife 100 may be used in a push-cutting operation in which the knife 100 is pushed in a direction away from the user to cut the material. In the push-cutting operation, the user grips the handgrip 150, and a front portion of the user's hand may engage the slip guard 160. As illustrated in FIGS. 1 and 2, the slip guard 160 extends below the handgrip 150. The slip guard 160 is configured to support (and protect) a front portion of the user's hand as the knife 100 is pushed in a direction away from the user in the push-cutting operation. In this manner, the slip guard 160 may be useful to prevent the user's hand from slipping off the front of the knife 100 during the push-cutting operation.

The knife 100 may be used in a pull-cutting operation in which the knife 100 is pulled in a direction toward the user to cut the material. In the pull-cutting operation, the user grips the handgrip 150, and a back portion of the user's hand may engage the hook portion 125 at an end of the knife 100. The hook portion 125 includes a tip that points in a direction toward the front of the knife 100 which holds the blade 110. As illustrated in FIGS. 1 and 2, the tip of the hook portion extends below the handgrip 150. The hook portion 125 is configured to support (and protect) the back portion of the user's hand as the knife 100 is pulled in a direction toward the user in the pull-cutting operation. In this manner, the hook portion 125 may be useful to prevent the user's hand from slipping off the back of the knife 100 during the pull-cutting operation. In one embodiment, the hook portion 125 is large enough to at least partially wrap around the hand of the user. Additionally, the hook portion 125 serves as a way to store the knife 100 in a belt loop, a wall hook tool, a pocket or a tool pouch. The hook portion 125 also allows the user to retrieve the knife 100 with one finger out of the pocket or the tool pouch.

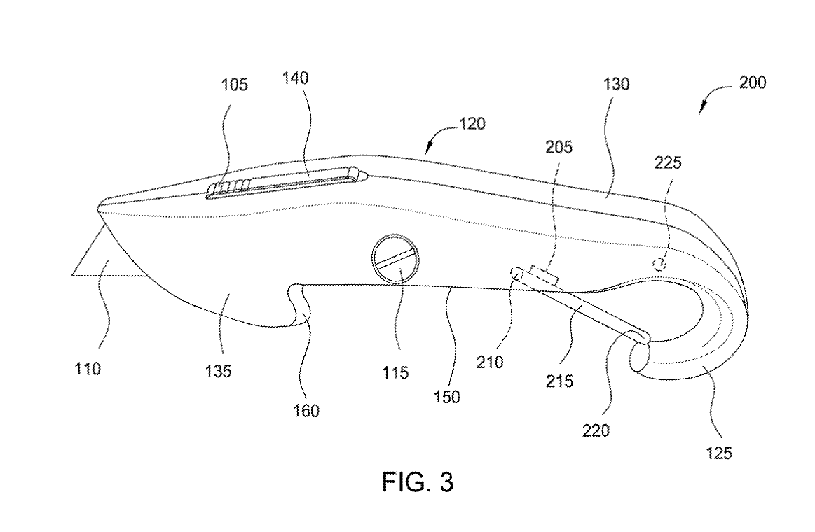

FIG. 3 is a view illustrating a knife 200 with the blade holder in an extended position. For convenience, the components on the knife 200 that are similar to the components on the knife 100 will be labeled with the same reference indicator. The knife 200 includes the blade holder that is movable between the retracted and the extended position by manipulating the button 105 on an upper portion of the knife 200. In the extended position, the cutting edge of the blade 110 extends from the handle 120 of the knife 200. In the retracted position (not shown), the cutting edge of the blade 110 is disposed within the handle 120 of the knife 200.

The knife 200 includes an arm member 215 (e.g., a carabineer arm) disposed near the hook portion 125. In one embodiment, the arm member 215 is a rod-shaped member or a flat plate member. The arm member 215 may be made from a metallic material or a composite material. The hook portion 125 and the arm member 215 allow the knife 200 to be attached and secured in any number of locations, such as a belt loop, a wall hook, a tool pouch, etc.

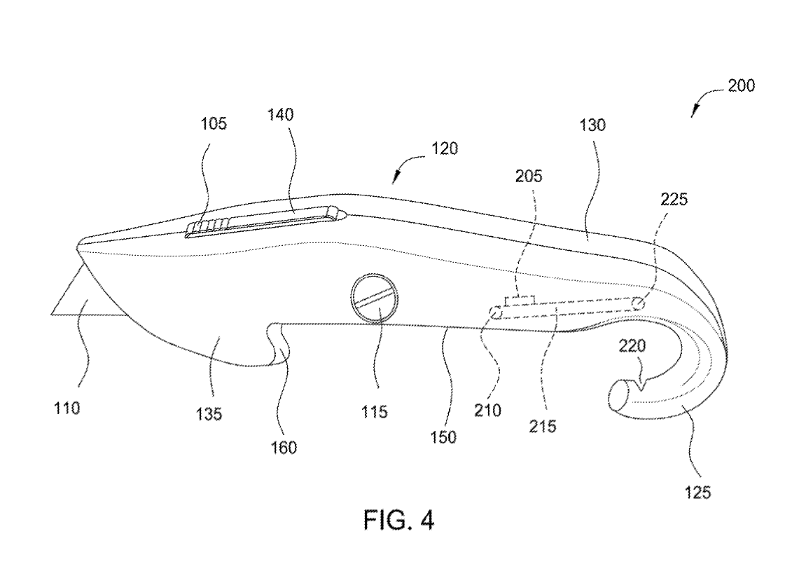

As shown in FIG. 3, one end of the arm member 215 is attached to the handle 125 at a hinge 210. The arm member 215 is configured to rotate around the hinge 210 between a closed position (FIG. 3) and an opened position (FIG. 4). A biasing member 205, such as a spring, is attached to the arm member 215 proximate the hinge 210. The biasing member 205 is configured to bias the arm member 215 in the closed position. Another end of the arm member 215 is configured to engage a notch 220 formed in the hook portion 125. The notch 220 holds the arm member 215 stationary when the arm member 215 is in the closed position.

FIG. 4 is a view illustrating the knife 200 with the arm member 215 in the opened position. To move the arm member 215 from the closed position to the opened position, a user applies a force to the arm member 215. When the force applied to the arm member 215 is greater than the force applied by the biasing member 205, the arm member 215 rotates around the hinge 210 toward the handle 210. A window (not shown) formed in the handle 120 is configured to receive the arm member 215 as the arm member 215 moves to the opened position. After the arm member 215 enters the window in the handle 120, an arm release member 225 disposed in the handle 120 engages a portion of the arm member 215 to hold the arm member 215 in the opened position (or storage position). In the opened position, the knife 200 may be used in a similar manner as set forth herein. To disengage the arm member 215 from the arm release member 225, the user may push on the arm member 215 or the user may push a button (not shown) attached to the arm release member 225. Once the arm member 215 is disengaged from the arm release member 225, the biasing member 205 urges the arm member 215 through the window in the handle 120 toward the closed position (FIG. 3). As set forth herein, in the closed position, the arm member 215 engages the notch 220 formed in the hook portion 125.

While the foregoing is directed to embodiments of the present invention, other and further embodiments of the invention may be devised without departing from the basic scope thereof, and the scope thereof is determined by the claims that follow.

1. A utility knife comprising:
a handle having a first end with an opening and a second end with a hook portion;
a blade;
a blade holder disposed in the handle, wherein the blade holder is configured to hold the blade, and wherein the blade holder is movable relative to the handle between an extended position where a cutting edge of the blade extends through the opening of the handle and a retracted position where the cutting edge of the blade is disposed in the handle.

2. The utility knife of claim 1, wherein the handle further includes a slip guard disposed between the first end and the second end of the handle.

3. The utility knife of claim 1, wherein the handle further includes a handgrip on a lower portion of the handle, the handgrip being disposed between the slip guard and the hook portion.

4. The utility knife of claim 3, wherein the slip guard extends to a point below the handgrip.

5. The utility knife of claim 1, further comprising an arm member having a first end attached to the handle by a hinge.

6. The utility knife of claim 5, wherein the arm member is rotatable around the hinge between a closed position and an opened position.

7. The utility knife of claim 6, wherein a second end of the arm member is configured to engage a notch in the hook portion when the arm member is in the closed position.

8. The utility knife of claim 6, wherein a second end of the arm member is configured to engage an arm release member disposed in the handle when the arm member is in the opened position.

9. The utility knife of claim 6, further comprising a biasing member disposed in the handle proximate the first end of the arm member.

10. The utility knife of claim 9, wherein the biasing member is configured to bias the arm member in the closed position.

11. A method of operating a utility knife, the method comprising:
providing the utility knife, the utility knife comprising a blade, a blade holder, a button, a handle having a first end with an opening and a second end with a hook portion;
grasping the knife in a manner that utilizes the handle;
manipulating the button on the knife to move the blade holder from a retracted position where a cutting edge of the blade is disposed in the handle to an extended position where the cutting edge of the blade extends through the opening of the handle; and
applying a force on the knife such that a portion of the force is applied to the hook portion of the handle.

12. The method of claim 11, wherein the utility knife further includes an arm member having a first end attached to the handle at a pivot point.

13. The method of claim 12, further comprising rotating the arm member around the pivot point from a closed position to an opened position.

14. The method of claim 13, wherein a second end of the arm member is configured to engage a notch in the hook portion when the arm member is in the closed position.

15. The method of claim 13, wherein a second end of the arm member is configured to engage an arm release member disposed in the handle when the arm member is in the opened position.

16. A utility knife comprising:
a handle having a hand grip positioned between a hook portion and a slip guard;
a blade holder configured to hold a blade, wherein the blade holder is movable relative to the handle between an extended position where a cutting edge of the blade extends through an opening of the handle and a retracted position where the cutting edge of the blade is disposed in the handle; and
an arm member disposed proximate the hook portion, the arm member having a first end attached to the handle at a pivot point.

17. The utility knife of claim 16, wherein the arm member is rotatable around the pivot point between a closed position and an opened position.

18. The utility knife of claim 17, wherein a second end of the arm member is configured to engage a notch in the hook portion when the arm member is in the closed position.

19. The utility knife of claim 17, wherein a second end of the arm member is configured to engage an arm release member disposed in the handle when the arm member is in the opened position.

20. The utility knife of claim 17, wherein the handle comprises a window configured to receive the arm member when the arm member is in the closed position.
